(19) United States
(12) Patent Application Publication
(10) Pub. No.: US 2012/0243520 A1
(43) Pub. Date: Sep. 27, 2012

(54) LOCATION-BASED ASSOCIATION FOR COMMUNICATIONS NETWORKS

(76) Inventors: Sung-Ju Lee, San Francisco, CA (US); Jung Gun Lee, Palo Alto, CA (US); John S. Balian, Westford, MA (US); Richard S. Davis, Salem, MA (US); Vincent Ma, Shrewsbury, MA (US); Hien Nguyen, Northborough, MA (US); Thomas S. Stefanski, Westford, MA (US); Raul Hernan Etkin, Mountain View, CA (US)

(21) Appl. No.: 13/069,072

(22) Filed: Mar. 22, 2011

(51) Int. Cl. H04W 60/00

(52) U.S. Cl. 370/338; 370/328

(57) ABSTRACT

In one implementation, a region descriptor associated with a communications access point and a location descriptor are accessed at a client. The client determines that a location described by the location descriptor is included within a region described by the region descriptor. The client then requests association with the communications access point in response to the determining.

### BACKGROUND

Wireless communications systems include computing devices and/or computing appliances that communicate one with another via electro-magnetic signals transmitted wirelessly. Some wireless communications systems are organized according to an infrastructure including one or more communications access points (or access points) and a group of client devices (or clients) such as computing devices. Each client is associated with an access point and the clients communicate one with another via that access point. When a client is associated with an access point, the access point accepts data from and forwards (or relays) data to that client. That is, to send data to a destination client, a source client sends the data to the access point with which the source client and the destination client are associated, and that access point then forwards (or relays) the data to the destination client.

In some wireless communications systems, the destination client and source client are associated with different access points and the access points are in communication one with another. Thus, to send data to the destination client, the source client sends the data to the access point with which the source client is associated, that access point forwards the data to the access point with which the destination client is associated, and access point with which the destination client is associated then forwards the data to the destination client. Furthermore, an access point can send data to and receive data from wired clients (i.e., local area network (“LAN”) stations). Thus, an access point can function as an intermediary between a wired communications system and a wireless communications system.

Typically, clients associate with an access point based on a received signal strength indicator (i.e., a measure of the strength of electro-magnetic signals received from the access point) or according to an identifier of the access point. For example, some clients are configured to associate with the access point with the best (i.e., strongest) received signal strength indicator. Such association can be referred to as dynamic because the client dynamically determines with which access point to associate. Other clients are configured to associate with a particular access point based on an identifier of that access point. That is, the access point broadcasts its identifier and such clients associate with the access point after receiving the identifier. Such association can be referred to as static because the client has be preconfigured to associated with a particular access point (or access points) having a predetermined identifier.

### BRIEF DESCRIPTION OF THE DRAWINGS

FIG. 1 is a schematic block diagram of a wireless communications system, according to an implementation.

FIG. 2 is a schematic block diagram of a communications access point, according to an implementation.

FIG. 3 is a schematic block diagram of a client device, according to an implementation.

FIG. 4 is a flowchart of a process to select an access point for association, according to an implementation.

FIG. 5 is an illustration of a management frame, according to an implementation.

FIG. 6 is an illustration of a region descriptor database, according to an implementation.

FIG. 7 is a flowchart of a process to provide a region descriptor, according to an implementation.

FIG. 8 is a schematic block diagram of a wireless communications system, according to an implementation.

FIG. 9 is a flowchart of a process to select an access point for association, according to another implementation.

FIG. 10 is a schematic block diagram of a system including a processor and storage media, according to an implementation.

### DETAILED DESCRIPTION

Client devices (or clients) within wireless communications systems are typically configured statically to associate with communications access points (or access points) based on an identifier (e.g., a name, an address such as a Medium Access Control (“MAC”) address, or another identifier) provided by those access points, or dynamically based on a received signal strength indicator (“RSSI”) determined from electro-magnetic signals received from each access point. Such association methodologies can be useful within wireless communications systems including moderate numbers of clients, but are often ill-suited to wireless communications systems including large numbers of clients.

For example, preconfiguring each client device to associate with a particular access point (or one of a group of access points with a common identifier) can be a time-consuming process. Furthermore, an access point with a strong signal path (e.g., a clear line-of-sight) to a large number of clients can become oversubscribed and overloaded (or congested) by those clients. That is, those clients will request association with that access point because the RSSI determined at each of those clients for that access point is better than the RSSIs for other access points at those clients.

As an example, a large number of clients (e.g., tens of thousands) can each include sensors such as humidity sensors, accelerometers, temperature sensors, acoustic sensors, seismic sensors, oxygen sensors, photon detectors, and/or other sensors to monitor conditions within a geographic area. Additionally, each client can include a wireless communications interface via which that client can communicate with one or more access points distributed throughout that geographic area to report or transfer data acquired at the sensor(s) of that client.

If the clients dynamically associate with the access point based on RSSIs determined (or generated) based on the electro-magnetic signals received from each access point (e.g., beacons and/or management frames broadcast by that access point to announce or advertise the availability, existence, and/or capabilities of that access point), the topology of the communications system (i.e., which clients are associated with which access points) is not determined before the clients and access points are deployed. Thus, many clients requesting association with and/or transmitting data to a single access point (e.g., due to a clear signal path to that access point) can overload that access point.

Alternatively, if the clients are statically associated with access points, care must be taken when deploying the clients and access point within the geographic area to ensure that the clients statically associated with each access point are able to communicate with that access point. That is, those clients must be positioned to have a sufficiently clear signal path to that access point to allow electro-magnetic signals to propagate between those clients and that access point. Such requirements can complicate deployment of the clients and access points.

Implementations discussed herein include systems, methods, and apparatus for clients to associate with access points based on the location of the clients. For example, in the example discussed above, each access point can be assigned a different region of the geographic area (i.e., a portion of the geographic area) and provided with a region descriptor of that region. As a specific example, an electro-magnetic signal propagation survey can be performed at the geographic area and the regions assigned to access points based on the electro-magnetic signal propagation properties identified by that survey. That is, each access point is associated with a region and provided with a description (i.e., a region descriptor) of that region.

Each client includes (or can access) a location identification module such as, for example, a Global Positioning System (“GPS”) receiver, via which that client can access a location descriptor to determine its location (e.g., its geographic location). The access points each transmit (e.g., broadcast) management frames or beacons that include the region descriptor of that access point. Each client receives the management frames and determines whether it is located within the region described by each region descriptor based on that region descriptor and the location descriptor received from the location identification module. If the client is located (i.e., is at a location) within a region described by a region descriptor, the client associates with the access point responsible for (or associated with) or servicing that region (i.e., the access point that transmitted that region descriptor).

Because the clients associate with access points based on location, the clients and access points can be distributed within the geographic area to avoid overloading of the access points. Said differently, the number of clients that will associate with each access point can be controlled by defining the region for which each access point is responsible (or with which each access point is associated) and deploying within that region a number of clients that access point can adequately service (i.e., host or communicate with). Moreover, because the clients are not statically associated with a particular access point, the location of each client within the geographic area relative to a particular access point is not important. That is, each client need not have an electro-magnetic signal propagation path to a particular access point. In other words, each client can associate with the access point responsible for the region in which that client is located rather than with a particular or predetermined access point. Thus, deployment of the clients can be simplified.

Implementations discussed herein are applicable to various clients and wireless communications systems. For example, the implementations discussed herein can be useful in wireless communications systems including large numbers of clients. Specifically, for example, such implementations allow deployment of large numbers of clients without configuration of the clients. That is, such implementations can allow zero-configuration deployment of large numbers of clients. As another example, these implementations can be useful for clients that are not configurable. That is, clients that cannot be configured to associate with a particular access point based on, for example, an identifier or name of that access point. Such clients can be referred to as dumb or unintelligent clients that are simple devices including a sensor such as a humidity sensor, an accelerometer, a temperature sensor, an acoustic sensor, a seismic sensor, an oxygen sensor, a photon detector, and/or other sensor, a wireless communications interface, and a location identification module.

As used herein, the singular forms “a,” “an,” and “the” include plural referents unless the context clearly dictates otherwise. Thus, for example, the term “client” is intended to mean one or more clients or a combination of clients. Additionally, as used herein, the term “module” refers to hardware, circuitry such as circuitry implementing computing logic, and/or software, firmware, programming, machine- or processor-readable instructions, commands, or code that are stored at a memory and executed or interpreted (or hosted) at a processor.

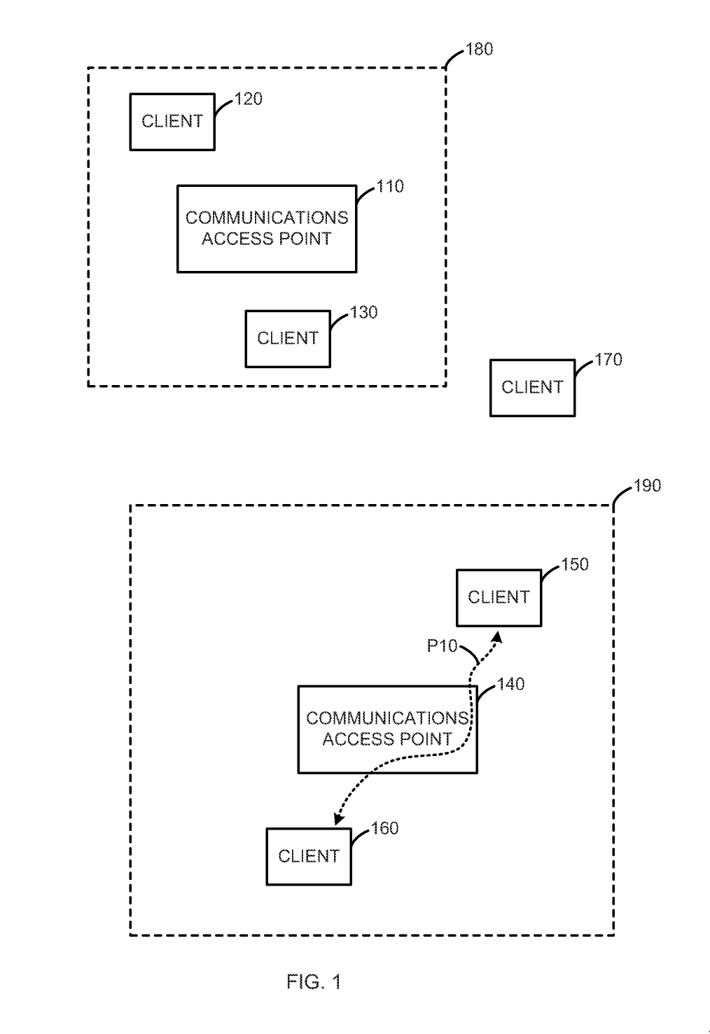

FIG. 1 is a schematic block diagram of a wireless communications system, according to an implementation. The wireless communications system (or communications system) illustrated in FIG. 1 includes communications access point (or access point) 110, access point 140, and clients 120, 130, 150, 160, and 170. Clients 120 and 130 and access point 110 are included within region 180. Regions 180 and 190 are each illustrated as having a rectangular perimeter. In other implementations, regions can have other perimeters such as polygonal (e.g., square, rectangular, hexagonal, or octagonal) perimeters or elliptical (e.g., circular) perimeters. That is, regions can be or have any of a variety of shapes such as polygons or ellipses. Access point 140 and clients 150 and 160 are included within (or are at or are within) region 190. Client 170 is not within region 180 or region 190.

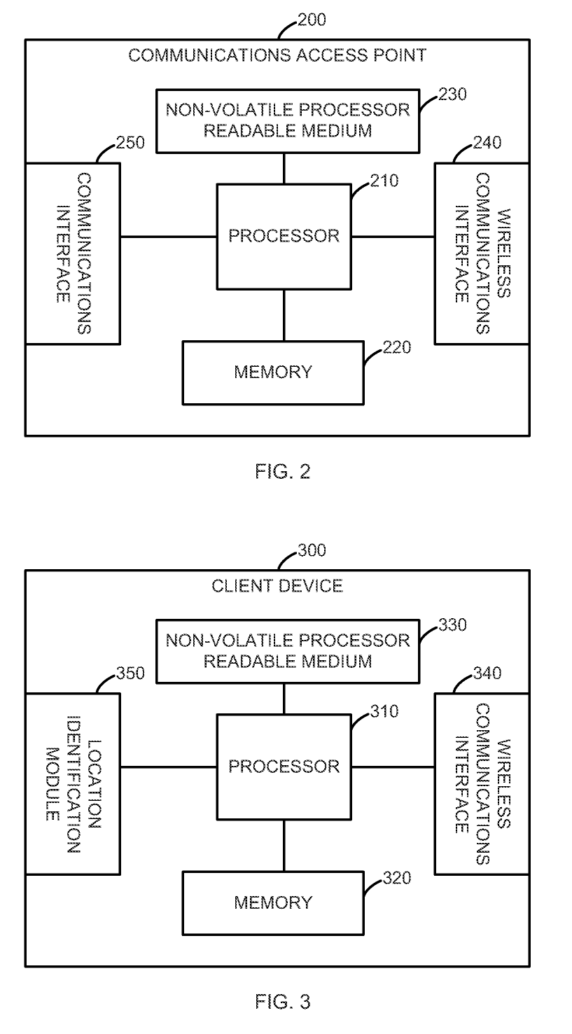

Access point 110 and 140 are computing devices or computing appliances. As an example of an access point, FIG. 2 is a schematic block diagram of a communications access point, according to an implementation. Access point 200 includes processor 210, memory 220, non-volatile (or non-transient) processor readable medium 230, wireless communications interface 240, and communications interface 250. Processor 210 is any of a variety of processors. For example, processor 210 can be a general-purpose processor or an application-specific processor and can be implemented as a hardware module and/or a software module hosted at a hardware module. A hardware module can be, for example, a microprocessor, a microcontroller, an application-specific integrated circuit (“ASIC”), a programmable logic device (“PLD”) such as a field programmable gate array (“FPGA”), and/or other electronic circuits that perform operations. A software module can be, for example, instructions, commands, and/or codes stored at a memory and executed (or hosted) at another processor. Such a software module can be defined using one or more programming languages such as Java™, C++, C, an assembly language, a hardware description language, and/or another suitable programming language. For example, a processor can be a virtual machine hosted at a computer server including a microprocessor and a memory.

In some implementations, processor 210 can include multiple processors. For example, processor 210 can be a microprocessor including multiple processing engines (e.g., computation, algorithmic or thread cores). As another example, processor 210 can be a computing device including multiple processors with a shared clock, memory bus, input/output bus, and/or other shared resources. Furthermore, processor 210 can be a distributed processor. For example, processor 210 can include multiple computing devices, each including a processor, in communication one with another via a communications link such as a computer network.

Memory 220 includes data and/or instructions or codes (e.g., computer codes or object codes) defining software modules (or software applications) that are executed by processor 210 during operation of access point 200. For example, memory 220 can include instructions that define an operating system, device drivers, a communications protocol stack, a database (i.e., a group of related data sets), and/or operational parameters such as an identifier of access point 200, and/or a region descriptor.

Similarly, non-volatile processor-readable medium 230 includes data and/or computer codes or instructions that are copied (or loaded) into memory 220 during a boot or initialization sequence of access point 200. That is, processor 210 (or another module such as a direct memory access module or basic input/output system (“BIOS”) module (not shown) of access point 200) can copy the data and/or instructions included at non-volatile processor-readable medium 230 to memory 220, and processor 210 can later access those data and/or instructions during operation of access point 200.

Examples of processor-readable media include, but are not limited to: magnetic storage media such as a hard disk, a floppy disk, and/or magnetic tape; optical storage media such as a compact disc (“CD”), a digital video disc (“DVDs”), a compact disc read-only memory (“CD-ROM”), and/or a holographic device; magneto-optical storage media; non-volatile memory such as read-only memory (“ROM”), programmable read-only memory (“PROM”), erasable programmable read-only memory (“EPROM”), electronically erasable read-only memory (“EEPROM”), and/or FLASH memory; and random-access memory (“RAM”). Examples of computer code include, but are not limited to, micro-code or micro-instructions, machine instructions, such as produced by a compiler, and files containing higher-level instructions that are executed by a computer using an interpreter. For example, an implementation may be realized or implemented using Java™, C++, or other object-oriented programming language and development tools. Additional examples of computer code include, but are not limited to, control signals, encrypted code, and compressed code.

In some implementations, non-volatile processor-readable medium 230 can be external to or removable from access point 200. For example, non-volatile processor-readable medium 230 can include a Universal Serial Bus™ (“USB”) interface (or interface module) and non-volatile processor-readable medium 230 can be FLASH memory device with a USB interface. Alternatively, non-volatile processor-readable medium 230 can be, for example, a Secure Digital™ (“SD”) memory device. In other implementations, non-volatile processor-readable medium 230 can be remote from access point 200 and access point 200 can access non-volatile processor-readable medium 230 via a communications link (e.g., a computer network). As a specific example, non-volatile processor-readable medium 230 can be (or be at) a data store or data storage service accessible via a communications link operatively coupled to communications interface 250, and access point 200 can boot by accessing non-volatile processor-readable medium 230 via communications interface 250.

Communications interface 250 is an interface module accessible to processor 210 to communicate with (i.e., transmit symbols representing data to and receive such symbols from) other processors and/or computing devices via a communications link. Communications interface 250 can be, for example, a telephone network interface, a twisted-pair network interface, a coaxial network interface, a fiber-optic network interface, a wireless network interface such as a wireless local area network (“WLAN”) or a cellular network, and/or some other network or communications interface.

Communications interface 250 can receive symbols from other communications interfaces (e.g., communications interfaces at other access points) via a communications link and send data represented by those symbols to processor 210. Moreover, communications interface 250 can receive data from processor 210 and transmit symbols representing those data via a communications link. For example, processor 210 can provide data frames having a destination address of a client associated with an access point other than access point 200 to that access point via communications interface 250.

Wireless communications interface 240 is an interface module that sends symbols (e.g., modulated electro-magnetic signals) to and receives symbols from clients of access point 200. That is, access point 200 communicates with clients via wireless communications interface 240. Wireless communications interface 240 can be, for example, a WLAN interface such as an IEEE 802.11a, b, g, or n network interface, a cellular network interface, a Bluetooth™ network interface, a ZigBee™ network interface, and/or some other wireless network or communications interface. In some implementations, communications interface 250 and wireless communications interface 240 send and/or receive data using a common protocol, frequency band or channel, modulation methodology, and/or have other similar operational characteristics. In other implementations, communications interface 250 and wireless communications interface 240 send and/or receive data using different protocols, frequency bands or channels, modulation methodologies, and/or have other different operational characteristics.

In one implementation, access point 200 transmits (or sends or broadcasts) beacons or management frames via wireless communications interface that are received by clients. As discussed in more detail herein, each client determines whether to associate with access point 200 and, if that client determines that it should associate with access point 200, associates (e.g., requests association) with access point 200 by transmitting an association request to access point 200. Access point 200 receives the association requests at wireless communications interface 240 and processor 210 determines whether to allow each client to associate with access point 200.

After a client has associated with access point 200, access point 200 functions as an intermediary between that client and other clients. That is, to send data to another client associated with access point 200, a client associated with access point 200 transmits the data to access point 200. Access point 200 receives the data at wireless communications interface 240, determines at processor 210 (e.g., based on a destination address for the data) that the data should be transmitted to another client associated with access point 200, and forwards the data to the other client via wireless communications interface 240. To send data to another client associated with a different access point, a client associated with access point 200 transmits the data to access point 200. Access point 200 receives the data at wireless communications interface 240, determines at processor 210 that the data should be transmitted to a client associated with another access point, and forwards the data to the other access point via communications interface 250. The other access point receives the data and forwards (i.e., transmits) the data to the destination client. Additionally, access point 200 point can be operatively coupled to a wired communications system such as a LAN via communications interface 250. Thus, clients of access point 200 can send data to and receive data from wired clients via access point 200. That is, access point 200 can function as an intermediary or bridge between a wired clients and wireless clients.

FIG. 3 is a schematic block diagram of a client device, according to an implementation. Access point 300 includes processor 310, memory 320, non-volatile (or non-transient) processor readable medium 330, wireless communications interface 340, and location identification module 350. Memory 320 includes data and/or instructions or codes (e.g., computer codes or object codes) defining software modules that are executed by processor 310 during operation of client device (or client) 300. For example, memory 320 includes instructions that define an operating system, device drivers, a communications protocol stack, a database (i.e., a group of related data sets), and/or operational parameters such as a location identifier accessed via location identifier module 350 at stored at memory 320, and/or a region descriptor.

Similarly, non-volatile processor-readable medium 330 includes data and/or instructions that are copied (or loaded) into memory 320 during a boot or initialization sequence of client 300. That is, processor 310 (or another module such as a direct memory access module (not shown) of client 300) can copy the data and/or instructions included at non-volatile processor-readable medium 330 to memory 320 and can later access those data and/or instructions during operation of client 300.

Wireless communications interface 340 is an interface module that sends symbols (e.g., modulated electro-magnetic signals) to and receives symbols from one or more access points. That is, client 300 communicates with one or more access points via wireless communications interface 340. Wireless communications interface 340 can be, for example, a WLAN interface such as an IEEE 802.11a, b, g, or n network interface, a cellular network interface, a Bluetooth™ network interface, a ZigBee™ network interface, and/or some other wireless network or communications interface.

Location identification module 350 accesses or generates location information related to client 300. As a specific example, location identification module 350 generates a location descriptor that identifies or describes a geographical location of client device 300. For example, location identification module 350 can be a GPS receiver and the location descriptor can be a latitude identifier, a longitude identifier, and/or an altitude identifier. Alternatively, the location descriptor can be based on a different coordinate system such as an Earth-Centered, Earth-Fixed (“ECEF”) coordinate system. As another example, location identification module 350 can be an Earth-based location identification module. That is, rather than receiving location signals based on which location identification module 350 generates a location descriptor from satellites, location identification module 350 can receive location signals from terrestrial transmitters.

As illustrated in FIG. 3, location identification module 350 is included within client 300. In some implementations, location identification module 350 is external to client 300. For example, client 300 can access location descriptors at location identification module 350 via an interface such as a Serial Peripheral Interconnect interface, an Inter-Integrated Circuit interface, a TTL RS232 interface, a Bluetooth™ interface, or a USB interface.

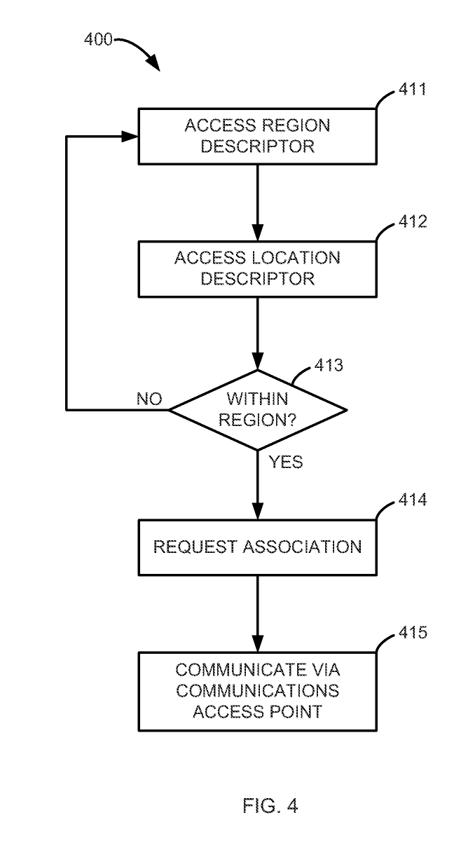

Referring to FIG. 1, clients 120 and 130 associate with access point 110 and clients 150 and 160 associate with access point 140 based on the location of clients 120, 130, 150, and 160. FIG. 4 is a flowchart of a process to select an access point for association, according to an implementation. Process 400 can be implemented as a hardware module, as a software module hosted at a computing device, and/or as a combination of a hardware module and a software module. For example, process 400 can be implemented as application-specific circuitry or as a software module including instructions stored at a memory and executed at a processor in communication with the memory. More specifically, for example, process 400 can be implemented at a client device (or client) within a communications system to select an access point with which the client will associate.

A region descriptor is accessed at block 411. For example, the region descriptor can be received from an access point, stored at a memory, and accessed at the memory when block 411 is executed at a processor of a client. As a specific example, a region descriptor can be received within an information element of a management frame (e.g., an 802.11-compliant management frame such as a beacon or probe response) transmitted by an access point associated with a region defined (or described) by the region descriptor. In other implementations, an identifier of an access point can be received from that access point (e.g., within a management frame or beacon) at a client, and the client can access the region descriptor within a database based on the identifier of the access point. That is, the client can perform a lookup in the database using the access point identifier as the key and receive the region descriptor as a result. The database can be, for example, stored at a memory of the client or accessible to the client via an interface such as a communications interface or an input/output interface such as a USB interface.

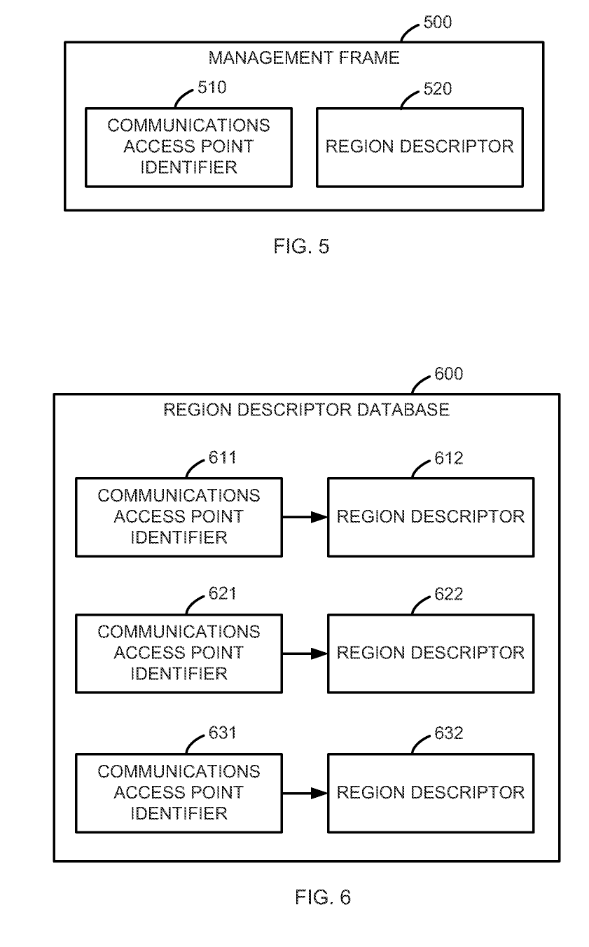

FIG. 5 is an illustration of a management frame, according to an implementation. Management frame 510 is a data set or group of symbols transmitted by an access point to provide information (e.g., information related to the operation, configuration, or management about the access point or a protocol or infrastructure supported by the access point) to clients. For example, management frame 500 can be a transmitted by the access point within a beacon that is periodically broadcast by the access point. In some implementations, management frame 510 can be an IEEE 802.11-compliant management frame (i.e., a management frame that complies with or satisfies one or more of IEEE 802.11 specifications such as IEEE 802.11a, b, g, or n. In other implementations, management frame 510 can be compliant with a different protocol, specification, or standard such as Bluetooth™ or ZigBee™.

As illustrated in FIG. 5, management frame 500 includes multiple portions or data sets. Specifically, management frame 500 includes communications access point identifier (or access point identifier) 510 and region descriptor 520. Access point identifier 510 is an identifier (e.g., a MAC address, name, or numeric identifier) of the access point that transmits management frame 500. Region descriptor 520 describes a region that the access point transmitting management frame 500 services (i.e., within which clients should associated with the access point).

In some implementations, management frame 500 can include additional or fewer portions than illustrated in FIG. 5. As a specific example, management frame 500 can exclude region descriptor 510. That is, rather than transmit region descriptor 520, an access point transmits access point identifier 510 to a client. The client can then access a region descriptor associated with that access point identifier. For example, the client can include a database or access a database remote to the client at which access point identifiers and region descriptors are stored.

As an example of such a database, FIG. 6 is an illustration of a region descriptor database, according to an implementation. Region descriptor database 600 includes a group of communications access point identifiers (access point identifiers) 611, 621, 631 and a group of region descriptors 612, 622, and 632. Access point identifiers 611, 621, 631 are associated with region descriptors 612, 622, and 632, respectively, within database 600. That is, given a particular access point identifier as a lookup key or query, the region descriptor associated with that access point identifier can be located within region descriptor database 600.

As a specific example, if a client provides access point identifier 621 to region descriptor database 600, region descriptor database 600 provides region descriptor 622. As another example, region descriptor database 600 can be a matrix (or table) within a memory. The matrix includes a column for access point identifiers and a column for region descriptors. The region descriptor associated (or related) with each access point identifier and that access point identifier are stored at a common row of the matrix. That is, the region descriptor is stored at the region descriptor column within the row and the access point identifier is stored at the access point identifier column within the row. In other implementations, region descriptor database can be another data store at which access point identifiers and related region descriptors are stored.

Referring to FIG. 4, location descriptor is then accessed at block 412. For example, the location descriptor can be accessed at a location identification module of the client. As another example, a memory location of a memory within the client can be updated periodically (e.g., by a processor of the client) with a current location descriptor. For example, the processor can periodically access (e.g., asynchronously receive) location descriptors from the location identification module and store the current location descriptor at the memory location. At block 412, the current location descriptor (i.e., the location descriptor that describes the current location of the client) is then accessed at the memory location.

The client then determines whether the client is within a region defined by the region descriptor at block 413. That is, the client determines whether the location described by the location descriptor is located within the region described by the region descriptor. For example, the client can calculate the perimeter of the region based on the region descriptor and determine whether the location of the client described in the location descriptor is within that perimeter. Referring to FIG. 1 as a specific example, clients 120 and 130 are within region 180 described by a region descriptor associated with access point 110. Access point 110 services region 180 and transmits region descriptors that describe region 180. Clients 150 and 160 are within region 190 described by a region descriptor associated with access point 140. Access point 140 services region 190 and transmits region descriptors that describe region 190.

Referring to FIG. 4, if the location of the client is within the region (i.e., the client is within the region) associated with the access point, the client transmits (or sends) an association request to the access point at block 414. Said differently, the client requests association (or to become associated with) the access point. In other words, the client requests that the access point accept data (e.g., data packets) from and forward data to the client. Typically, the access point then determines whether to associate with the client and transmits an association acknowledgment (e.g., a data set or group of symbols) to the client to indicate that the client has been associated with the access point.

Referring again to FIG. 1, clients 120 and 130 associate with (or request association by sending association requests to) access point 110 because clients 120 and 130 are located within region 180. Similarly, clients 150 and 160 associate with (or request association by sending association requests to) access point 140 because clients 150 and 160 are located within region 190.

Referring to FIG. 4, the client then communicates with other clients, computing devices, and/or services (e.g., a data storage service or a configuration service) via the access point at block 415. That is, the client sends and receives data from the other clients, computing devices, and/or services via the access point.

If the location described by the location descriptor is not within the region described by the region descriptor at block 413, process 400 returns to block 411 to access another region descriptor. Thus, the client can access a group of region descriptor (e.g., received from a group of access points or from a database of region descriptors accessible to the client) and associated with an access point associated with a region within which the client is located. As illustrated in FIG. 1, client 170 is not within region 180 or region 190. Thus, client 170 does not associate with access point 110 or access point 140.

Process 400 can include additional or fewer blocks than those illustrated in FIG. 4. For example, process 400 can include a block at which a client implementing process 400 determines whether that client is currently associated with an access point. As a specific example, such a block can be included between blocks 412 and 413. If the client is currently associated with an access point, the client does not determine whether the location described by the location descriptor is within the region described by the region descriptor. If the client is not currently associated with an access point, the client determines at block 413 whether the location described by the location descriptor is within the region described by the region descriptor. Additionally, one or more blocks can be rearranged or discarded. For example, the location descriptor can be accessed before the region descriptor is accessed. Furthermore, although process 400 is discussed above with reference to an example environment including a client device (or client), process 400 is applicable within other environments.

Referring to FIG. 1, after clients 120 and 130 are associated with access point 110 clients 120 and 130 can communicate one with another, with computing devices, and/or with services via access point 110. Similarly, after clients 150 and 160 are associated with access point 140 clients 150 and 160 can communicate one with another, with computing devices, and/or with services via access point 140. As a specific example, path P10 illustrates a communications path between clients 150 and 160 through access point 140. That is, client 160 sends data to and receives data from client 150 via access point 140. Similarly, client 150 sends data to and receives data from client 160 via access point 140.

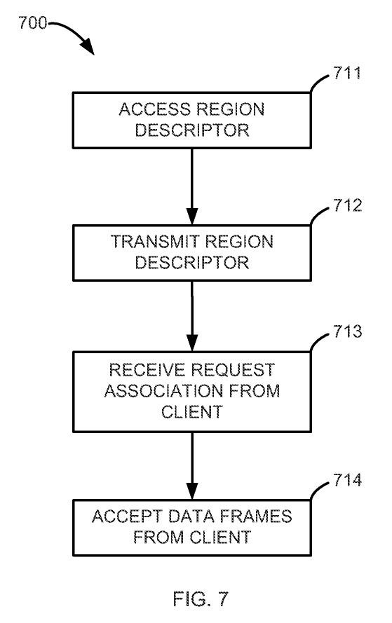

FIG. 7 is a flowchart of a process to provide a region descriptor, according to an implementation. Process 700 can be implemented as a hardware module, as a software module hosted at a computing device, and/or as a combination of a hardware module and a software module. For example, process 700 can be implemented as application-specific circuitry or as a software module including instructions stored at a memory and executed at a processor in communication with the memory. More specifically, for example, process 700 can be implemented at a communications access point (or access point) within a communications system.

A region descriptor is accessed at block 711. For example, an access point implementing process 700 can access a region descriptor that describes a region associated with that access point. More specifically, in this example the access point can be preconfigured to include the region descriptor at a memory or within a file at the access point. That is, the region descriptor can be predetermined for the access point and the access point can be configured or programmed to include the region descriptor. In other implementations, the access point can access the region descriptor from a service via a communications interface. That is, the access point can request a region descriptor associated with the access point from a database or management (e.g., a communications system management) service.

In yet other implementations, the access point can generate the region descriptor. For example, the access point can include (or be in communication with) a location identification module at which the access point can access a location descriptor that describes a location of the access point. Additionally, the access point can access (e.g., at a memory or file of the access point or at a service) a region specification and generate the region descriptor based on the location descriptor and the region specification. More specifically, the region specification can specify the perimeter or shape of a region. For example, the region specification can specify a circle with a radius of 100 meters, a square with side lengths of 75 meters, or some other perimeter or shape. The access point can generate the region descriptor by modifying the region specification to be relative to the location of the access point (i.e., the location described by the location descriptor). For example, with reference to the region specification examples above, a region descriptor can describe a circle with a radius of 100 meters or a square with side lengths of 75 meters centered at the location.

The region descriptor is then transmitted by the access point at block 712. For example, the access point can include the region descriptor within a management frame of a beacon periodically broadcast by the access point. In some implementations, an identifier of the access point is also transmitted with the region descriptor. Typically, one or more clients receive the region descriptor and request association with the access point if those clients are located within the region described by the region descriptor.

An association request is received from the client at block 713 and the access point determines whether to associate with that client. For example, the access point and client can perform a handshake or other authentication protocol and the access point can determine whether to associate with the client based on the result of the handshake or other authentication protocol. In some implementations, the association is based on a specification or protocol such as IEEE 802.11a, b, g, or n. That is, the association can proceed according to a preexisting specification or protocol. Thus, process 700 can be an extension of a preexisting protocol or specification.

After the access point has associated with the client, the data frames (i.e., frames or data sets including data or data values) are accepted from the client at block 714. In other words, the client can communicate with other clients, computing devices, and/or services via the access point. Furthermore, the access point forwards data frames addressed or directed to the client (e.g., based on a destination address included within those data frames) to the client when such data frames are received at the access point from, for example, other clients, computing devices, and/or services.

Process 700 can include additional or fewer blocks than those illustrated in FIG. 7. Additionally, one or more blocks can be rearranged or discarded. Furthermore, although process 700 is discussed above with reference to an example environment including an access point, process 700 is applicable within other environments.

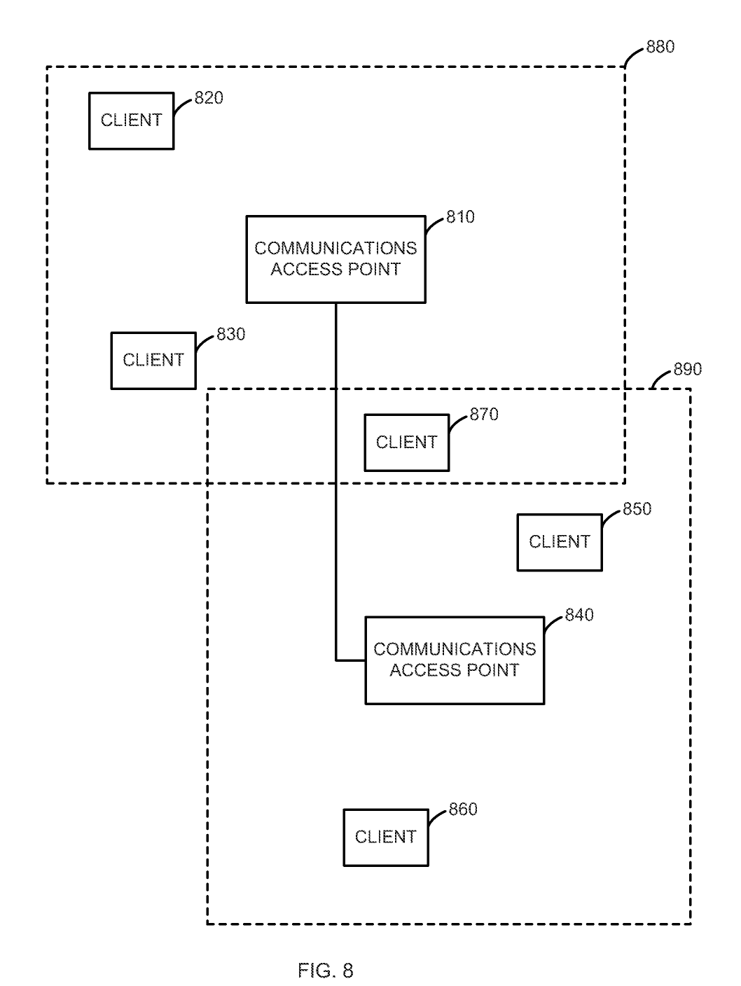

FIG. 8 is a schematic block diagram of a wireless communications system, according to an implementation. The wireless communications system (or communications system) illustrated in FIG. 8 includes communications access point (or access point) 810, access point 840, and clients 820, 830, 850, 860, and 870. Clients 820 and 830 and access point 810 are included within region 880. Regions 880 and 890 are each illustrated as having a rectangular perimeter. In other implementations, regions can have other perimeters such as polygonal (e.g., square, rectangular, hexagonal, or octagonal) perimeters or elliptical (e.g., circular) perimeters. That is, regions can be or have any of a variety of shapes such as polygons or ellipses. Access point 840 and clients 850 and 860 are included within (or are at or are within) region 890.

As illustrated in FIG. 8, access point 810 is operatively coupled to access point 840. Access points 810 and 840 can be operatively coupled one with another via a communications link such as a cable, an optical fiber, a wireless communications link such as a radio-frequency or microwave communications link, and/or some other communications link. Thus, access point 810 can communicate with access point 840 via the communications link. For example, client 820 can communicate with client 860 by transmitting a data frame to access point 810. Access point 810 then forwards the data frame to access point 840 and access point 840 forwards the data frame to client 860.

Client 870 is within region 880 and within region 890. Because client 870 is within both of regions 880 and 890, client 870 determines with which of access points 810 and 840 to associate. In some implementations, client 870 can associate (or request association) with the access point of access points 810 and 840 from which it first receives a region descriptor.

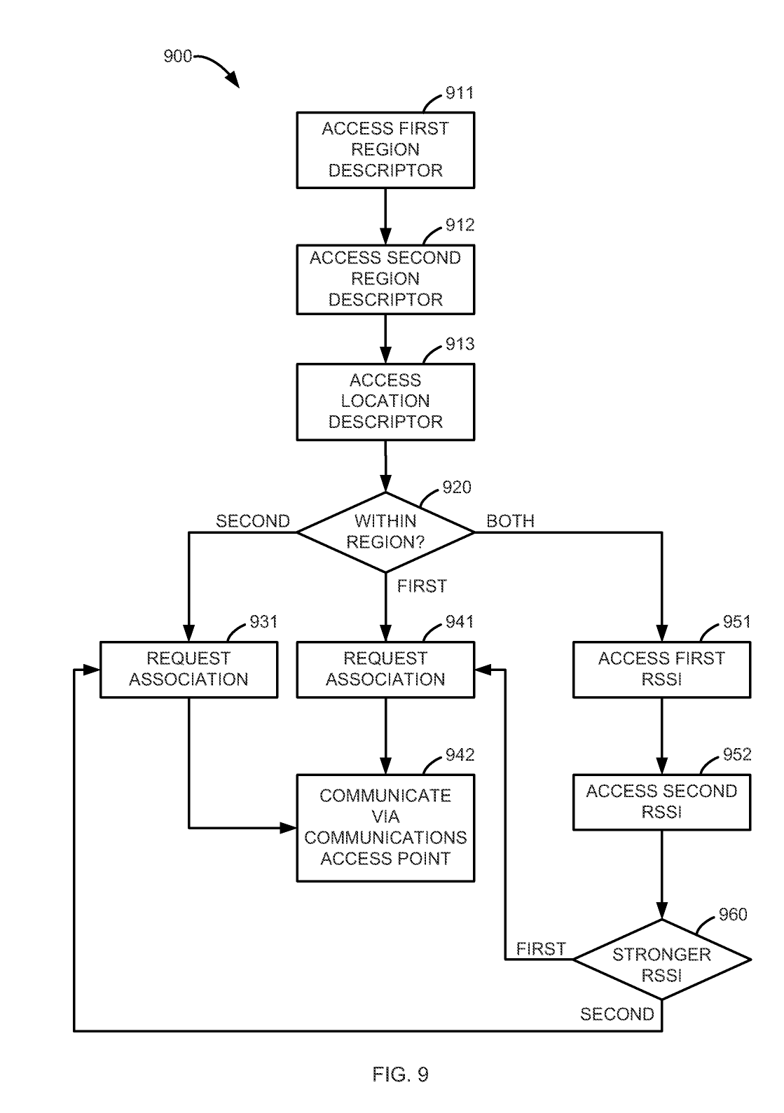

In other implementations, client 870 can select the access point with which client 870 will associate using other methodologies. As a specific example, client 870 can associate with the access point of access points 810 and 840 with which client 870 can establish a better or stronger wireless communications link. For example, client 870 can associate with the access point from access points 810 and 840 for which client 870 has calculated a stronger (or higher) RSSI. Such a methodology is illustrated in FIG. 9.

FIG. 9 is a flowchart of a process to select an access point for association, according to another implementation. Process 900 can be implemented as a hardware module, as a software module hosted at a computing device, and/or as a combination of a hardware module and a software module. For example, process 900 can be implemented as application-specific circuitry or as a software module including instructions stored at a memory and executed at a processor in communication with the memory. More specifically, for example, process 900 can be implemented at a client device (or client) within a communications system to select an access point with which the client will associate.

A first region descriptor is accessed at block 911. For example, the region descriptor can be received from an access point and stored at a memory, and accessed at the memory when block 911 is executed at a processor of a client. As a specific example, a region descriptor can be received within an information element of a management frame transmitted by an access point associated with a region defined by the region descriptor. In other implementations, an identifier of an access point can be received from that access point at a client, and the client can access the region descriptor within a database based on the identifier of the access point. That is, the client can perform a lookup in the database using the access point identifier as the key and receive the region descriptor as a result. The database can be, for example, stored at a memory of the client or accessible to the client via an interface such as a communications interface or an input/output interface such as a USB interface.

A second region descriptor is then accessed at block 912. The first region descriptor is associated with a first access point and the second region descriptor is associated with a second access point. In other implementations, additional region descriptors are received from other access points. That is, a client implementing process 900 can receive additional region descriptors from other access points.

A location descriptor is then accessed at block 913. For example, the location descriptor can be accessed from a location identification module of the client. As another example, a memory location of a memory within the client can be updated periodically with a current location descriptor. For example, the processor can periodically access (e.g., asynchronously receive) location descriptors from the location identification module and store the current location descriptor at the memory location. At block 913, the current location descriptor is then accessed at the memory location.

The client then determines whether the client is within a region defined by the region descriptor at block 920. That is, the client determines whether the location described by the location descriptor is located within the region described by the first region descriptor or the region described by the second region descriptor. For example, the client can calculate the perimeter of the regions based on the first and second region descriptors, and determine whether the location of the client described in the location descriptor is within either perimeter (or region).

If the location of the client is within the region described by the first region descriptor, process 900 proceeds to block 941, at which the client requests association with the access point that provided the first region descriptor and communicates with other clients, computing devices, and/or services via that access point at block 942. If the location of the client is within the region described by the second region descriptor, process 900 proceeds to block 931, at which the client requests association with the access point that provided the second region descriptor and communicates with other clients, computing devices, and/or services via that access point at block 942.

If the location of the client is within the region described by the first region descriptor and within the region described by the second region descriptor, process 900 proceeds to block 951 at which the client accesses a first RSSI determined based on electro-magnetic signals received from the access point that provided the first region descriptor. A second RSSI determined based on electro-magnetic signals received from the access point that provided the second region descriptor is accessed at block 952.

A client implementing process 900 then determines which RSSI is stronger (or better or preferred) at block 960 and proceeds to one of blocks 931 and 941. If the first RSSI is stronger (the second RSSI is weaker), process 900 proceeds to block 941 to request association with the access point that provided the first region descriptor as discussed above. If the second RSSI is stronger (the first RSSI is weaker), process 900 proceeds to block 931 to request association with the access point that provided the second region descriptor as discussed above.

If the location described by the location descriptor is not within the region described by the first region descriptor or the region described by the second region descriptor at block 920, process 900 returns to block 911 to access or wait for another region descriptor. Process 900 can include additional or fewer blocks than those illustrated in FIG. 9. Additionally, one or more blocks can be rearranged or discarded. Furthermore, although process 900 is discussed above with reference to an example environment including a client device (or client), process 900 is applicable within other environments.

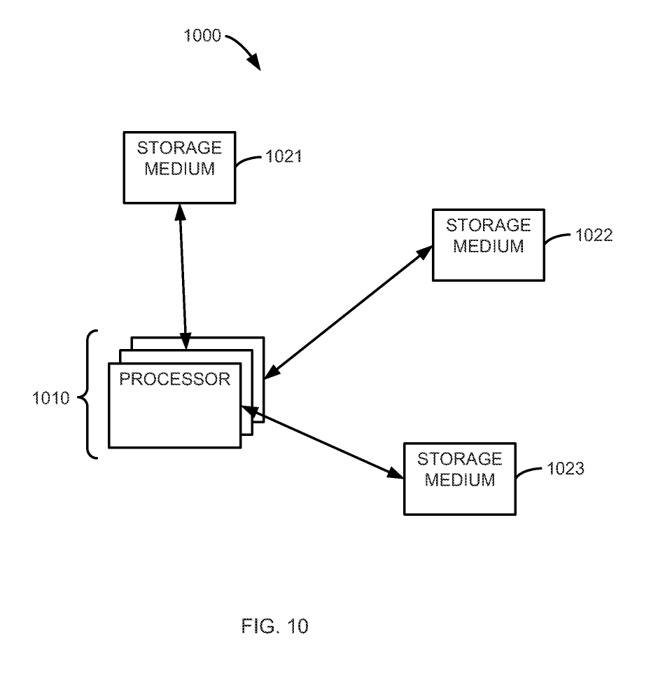

As an example of a system including one or more processors and processor-readable storage media, FIG. 10 is a schematic block diagram of a system including a processor and storage media, according to an implementation. As illustrated in FIG. 10, system 1000 includes one or more processors 1010 operatively coupled to storage medium 1021, storage medium 1022, and storage medium 1023. One or more processors 1010 can access instructions or code at storage medium 1021, storage medium 1022, and storage medium 1023. Storage media 1021, 1022, and 1023 can be any non-transitory processor-readable media and/or related devices to access non-transitory processor-readable media.

For example, storage medium 1021 can be a hard disk drive including a magnetic storage medium, storage medium 1022 can be an optical drive such as a DVD drive and can accept DVD storage media on which processor-readable instructions such as processor-readable instructions that implement display control module or a display client module can be stored, and storage medium 1023 can be a FLASH memory drive with a USB interface. In some implementations, storage media 1021, 1022, and/or 1023 can be local to (e.g., coupled to a common computing device) one or more processors 1010. In some implementations, storage media 1021, 1022, and/or 1023 can be remote from (e.g., coupled to a separate computing device) one or more processors 1010 and in communication with one or more processors 1010 via a communications link. Furthermore, one or more of storage media 1021, 1022, and/or 1023 can be local to one or more processors 1010 and one or more of the remaining of storage media 1021, 1022, and/or 1023 can be remote from one or more processors 1010.

As a more specific example, one or more processors 1010 can be included within a computing device having an internal hard disk drive data store represented by storage medium 1021 and a removable solid-state data store such as a Secure Digital High-Capacity (“SDHC”) memory card represented by storage medium 1022. The computing device can also include a USB host controller to communicate with a USB FLASH memory drive represented by storage medium 1023. One or more processors 1010 can access processor-readable instructions such as processor-readable instructions that implement a display control module at any of storage media 1021, 1022, and/or 1023. Said differently, one or more processors 1010 can interpret or execute instructions at processor-readable media via storage medium 1021, storage medium 1022, and/or storage medium 1023. For example, a computing device can access and/or host a software application stored at one or more of storage medium 1021, storage medium 1022, and/or storage medium 1023 that includes codes that when executed implement, for example, process 700 discussed above in relation to FIG. 7. That is, the computing device can host (or execute) the software application to function as an access point.

Alternatively, for example, storage media 1021 and 1022 can be remote from a computing device including one or more processors 1010 and storage medium 1023 can be local to that computing device. The computing device including one or more processors 1010 can access (e.g., download) a software application that includes codes that when executed implement process 900 discussed above in relation to FIG. 9 from one or both of remote storage media 1021 or 1022 via a communications link such as a communications network to local storage medium 1023 and execute the software application from local storage medium 1023. As a specific example, the computing device can be a thin client device.

In some implementations, system 1000 can include one or more memories such as RAM that function as a cache between one or more of storage medium 1021, storage medium 1022, and/or storage medium 1023 and one or more processors 1010 for instructions or code stored (or accessible) at one or more of storage medium 1021, storage medium 1022, and/or storage medium 1023.

While certain implementations have been shown and described above, various changes in form and details may be made. For example, some features that have been described in relation to one implementation and/or process can be related to other implementations. As a specific example, implementations described in relation to communications systems including numerous clients with sensors can be applicable to other environments. In other words, processes, features, components, and/or properties described in relation to one implementation can be useful in other implementations. Furthermore, it should be understood that the systems and methods described herein can include various combinations and/or sub-combinations of the components and/or features of the different implementations described. Thus, features described with reference to one or more implementations can be combined with other implementations described herein.

What is claimed is:

1. A communications system association method, comprising:
accessing a region descriptor associated with a communications access point;
accessing a location descriptor;
determining that a location described by the location descriptor is included within a region described by the region descriptor; and
requesting association with the communications access point in response to the determining.

2. The method of claim 1, wherein the region descriptor is included within an information element of an IEEE 802.11-compliant management frame provided by the communications access point.

3. The method of claim 1, wherein the region descriptor describes a polygon.

4. The method of claim 1, wherein the region descriptor describes an ellipse.

5. The method of claim 1, further comprising:
communicating with a computing device via the communications access point after the requesting association.

6. The method of claim 1, further comprising:
receiving the region descriptor from the communications access point.

7. The method of claim 1, further comprising:
receiving an identifier of the communications access point, the accessing the region descriptor at a region descriptor database based on the identifier.

8. The method of claim 1, wherein the region descriptor is a first region descriptor, the region is a first region, and the communications access point is a first communications access point, the method further comprising:
accessing a second region descriptor associated with a second communications access point;
determining that the location described by the location descriptor is included within a second region described by the second region descriptor;
determining that a first signal strength indicator associated with the first communications access point is weaker than a second signal strength indicator associated with the second communications access point; and
requesting association with the second communications access point.

9. The method of claim 1, wherein the region descriptor is a first region descriptor, the region is a first region, and the communications access point is a first communications access point, the further comprising:
accessing a second region descriptor associated with a second communications access point;
determining that the location described by the location descriptor is not included within a second region described by the second region descriptor; and
requesting association with the first communications access point in response to the determining.

10. A communications system apparatus, comprising:
a location identification module to generate a location descriptor;
a wireless communications module to communicate with a communications access point; and
a processor operatively coupled to the location identification module and the wireless communications module, the processor configured to access the location descriptor and a region descriptor and to request association with a communications access point if a location described by the location descriptor is within a region described by the region descriptor.

11. The apparatus of claim 10, wherein the processor is configured to perform an IEEE 802.11-compliant association with the communications access point if the location described by the location descriptor is within the region described by the region descriptor.

12. The apparatus of claim 10, wherein:
the region descriptor is received at the wireless communications module; and
the processor is configured to access the location descriptor at the wireless communications module.

13. The apparatus of claim 10, further comprising:
a memory operatively coupled to the processor and including a region descriptor database, the region descriptor included at the region descriptor database, the processor configured to access the location descriptor at the memory.

14. A processor-readable medium storing code representing instructions to cause a processor to perform a process, the process comprising:
accessing a region descriptor;
broadcasting the region descriptor via a wireless communications module; and
receiving an association request from a client.

15. The processor-readable medium of claim 14, wherein the region descriptor describes a geographic region with a polygonal perimeter.

16. The processor-readable medium of claim 14, wherein the region descriptor describes a geographic region with an elliptical perimeter.

17. The processor-readable medium of claim 14, further comprising:
accepting data frames from the client after the receiving the association request.

18. The processor-readable medium of claim 14, wherein the region descriptor is broadcast within an information element of an IEEE 802.11-compliant management frame.

19. The processor-readable medium of claim 14, further comprising:
defining the region descriptor based on a location descriptor and a region specification.

20. The processor-readable medium of claim 14, wherein the region descriptor is predetermined.
